(19) United States
(12) Patent Application Publication
(10) Pub. No.: US 2017/0195275 A1
(43) Pub. Date: Jul. 6, 2017

(54) DELIVERY OF EMAIL TO A MOBILE DEVICE

(71) Applicant: Dell Products L.P., Round Rock, TX (US)

(72) Inventors: Matthew L. Domsch, Austin, TX (US); Satya Mylvara, Sunnyvale, CA (US); Robert Milo Keathley, Spicewood, TX (US)

(73) Assignee: Dell Products L.P., Round Rock, TX (US)

(21) Appl. No.: 14/984,226

(22) Filed: Dec. 30, 2015

(51) Int. Cl. H04L 12/58; H04L 29/06; H04W 88/02; H04L 29/08

(52) U.S. Cl. CPC H04L 51/24; H04L 67/26; H04L 69/28; H04W 88/02

(57) ABSTRACT

A method, system, and software for notifying a mobile device of mail updates includes a polling service, which resides in a polling resource off of the mobile device, detecting a mail notification request from the mobile device and launching a polling thread to establish a network connection with a mail delivery agent associated with an enterprise mail server and to long-poll the delivery agent to determine if the mail server has new mail for the mobile device. If the polling service receives a response to the long-poll, the polling resource initiates a push notification via an API exposed by a push notification resource of a third party provider. The polling resource may issue polling threads on behalf of a plurality of mobile devices and may maintain a polling thread database to monitor active polling threads and terminate threads based on criterion/criteria pertaining to the thread's age or other parameter(s).

### TECHNICAL FIELD

Disclosed subject matter pertains to mobile devices and, more specifically, notification and delivery of emails to mobile devices from an enterprise mail server.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information.

Because information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. Information handling systems may also include a variety of hardware and software components that may be configured to process, store, and communicate information and may include one or more computer systems, data storage systems, and networking systems.

Particularly when used in conjunction with the World Wide Web and other public and private IP-based networks that support standard HTTP methods, information handling systems may provide resources that interact in accordance with a representational state transfer (REST) model having, as some of its characteristics, a client/server structure in which the set of state transition actions available to a client consists of server-identified hypermedia including, as the most pervasive examples, hyperlinks and corresponding hypertext. Accordingly, when implemented within a REST-compliant network, system, or interface, an information handling system may function as a client, a server, or intermediary, e.g., a proxy, gateway, or firewall that supports hyperlink-based resources.

Significantly, a standard REST-compliant or “RESTful” server cannot initiate a connection with a client nor send an unrequested response to a client. A RESTful server cannot, therefore, push asynchronous events to clients. Timely receipt of asynchronous events by a client requires the client to poll the applicable server periodically for new content. The significance of this fundamental constraint increases with the value or importance of immediacy in the context of a particular client application, especially when the client device is largely controlled by a third party provider. One application in which the pull-only constraint on client devices raises significant implementation issues is the delivery of email updates to mobile devices.

Mobile device users expect timely, near immediate, notification and delivery of email to their mobile devices. However, because email messages are delivered to cloud-based or premises-installed mail servers, the mobile device must obtain email notification and delivery indirectly, by polling the mail server. Typically, however, prior solutions to this problem require a polling application installed on the mobile device that maintains a persistent connection with a mail delivery agent (MDA) and executes frequent polling requests, consuming undesirable power and thereby increasing the frequency with which the mobile device's battery requires recharging. In addition, the polling application, as a client-side application, will not be able to poll the MDA during times when the mobile device loses connectivity or when the mobile device operating system puts an application “to sleep” or otherwise suspends or terminates the application.

### SUMMARY

In accordance with the teachings of the present disclosure, disadvantages and problems associated with providing timely mail notifications to a mobile device are addressed.

In accordance with method embodiments of subject matter disclosed herein, a method of providing mobile update notifications to a mobile device includes an off-device service, referred to herein as the mail polling service (MPS), that detects a mail notification request from the mobile device and launches a polling thread to perform polling thread operations. In at least one embodiment, the polling thread operations include establishing a network connection with an MDA, e.g., a cloud-based enterprise-class data synchronization resource including, as one non-limiting example, MS Exchange ActiveSync, from Microsoft. The MDA may be configured for communicating with an enterprise mail server (EMS) and executing a long-poll of the MDA on behalf of the mobile device to determine if the EMS has new mail for an email account associated with the mobile device. If the MPS receives a response from the polling thread, the MPS may request, either directly or via a cloud-based utility, a push notification resource to push a mail notification to the mobile device.

To address issues that may result from an accumulation of orphaned or abandoned polling threads, the polling thread may be terminated in accordance with particular criteria when no response to the polling thread has been received. The particular criteria may include an expiration criterion corresponding to a duration of the long-poll exceeding an expiration interval and a timeout criterion corresponding to an interval between the mail notification request and a subsequent mail notification request exceeding a timeout interval. The timeout criterion terminates threads when the applicable mobile device/mail user agent has been silent for a particular duration. The expiration criterion, which may be more relaxed than the timeout criterion in some embodiments, terminates all polling threads without regard to mobile device activity. To prevent the criteria from terminating polling threads too aggressively, a default value of the expiration interval may be set with a range of approximately 18 to 30 hours with 24 hours as a representative value while a default for the timeout interval may be defined explicitly, e.g., 6 hours, or in terms of the expiration interval, e.g., a ratio of the expiration interval to the timeout interval is approximately N where N is the range of approximately 2 to approximately 8 with a ratio of 4 as a representative value.

The resource in which the MPS resides, referred to herein as the mail polling resource, may be an on-premises gateway (OPG) of an enterprise network, where the enterprise network is a private network, isolated from an adjacent public network including, as an example, the Internet, by one or more enterprise firewall(s). In these embodiments, the OPG may provide the MPS via mail polling instructions for launching the polling thread in response to the mail notification request. The mail polling instructions may include instructions for launching the polling thread in response to the mail notification request, subject to determining that no other polling thread associated with the mobile device is currently active.

In accordance with software or computer readable media embodiments of subject matter disclosed herein, a computer readable medium may include processor executable instructions for causing a processor of a mail polling resource to provide a mail polling service by executing processor-executable mail polling instructions corresponding to mail polling operations. The mail polling operations may include detecting a mail update request from a mobile device and launching a polling thread corresponding to the mobile device responsive to determining that no polling thread corresponding to the mobile device exists. The polling thread may, in at least some embodiments, poll an MDA for an indication of new mail in conjunction with a mail account associated with the mobile device. The polling thread may initiate an authenticated push notification request upon receiving or otherwise detecting a response from the polling thread. The push notification request may cause a push notification resource of a third party provider to push an indication of new mail to the mobile device.

In at least one embodiment, the polling thread is configured to perform polling operations that include: establishing a network connection with an MDA coupled to the EMS, providing the MDA with mail credentials corresponding to the mobile account, and performing a long-poll of the MDA for the indication of new email.

Long polling refers to issuing individual polling requests at a frequency that is deliberately low so that each individual polling request remains, in the absence of an unintended interruption or explicit termination of the network connection, open and active for a duration of minutes, hours, or longer. If the recipient of a long poll request, i.e., the polled resource, does not have any information available, the network connection between the resources is maintained rather than terminated as occurs in a conventional polling request. When new information, e.g., an indication of a new mail message, arrives, the polled resource sends, with little or no latency, a response to the polling resource, completing the open HTTP/S request. The quasi-synchronous response that long-polling produces substantially reduces the inherent latency of conventional polling attributable to the interval between the arrival of new data and the start of the next periodic or non-periodic polling request.

The long-poll may persist until the long poll either returns a long poll response to the MPS or until the long poll terminates, in accordance with particular criteria, before the long poll returns a response. In at least one embodiment, the particular criteria include a timeout criterion in accordance with a duration between successive mail notification requests exceeding a timeout interval and an expiration criterion in accordance with a duration of the polling thread exceeding an expiration interval.

In at least some embodiments, the polling operations may include creating a record corresponding to the polling thread in a database, storing values indicative of the timeout interval and the expiration interval in the database record corresponding to the mobile device, and monitoring a duration of the long poll and a duration of an interval since the most recent mail notification request was sent. A default value of the expiration interval may be defined relative to the expiration interval and, in these embodiments, a ratio of the expiration interval to the timeout interval may be in the range of approximately 2 to approximately 8 and may be approximately 4. The default value of the expiration interval, in at least one embodiment, is in the range of approximately 18 to approximately 30 hours and may be approximately 24 hours.

In at least some embodiments, the mail polling resource comprises an on-premises gateway server on an enterprise network that is demarcated by an enterprise firewall such that the mail account credentials may be provided to the mail polling resource without exposing the mail account credentials to a non-enterprise domain. Establishing the network connection with the MDA may include obtaining mail account credentials for the mail account and providing the mail account credentials to the MDA in conjunction with the polling thread.

In at least some embodiments, initiating the push notification request includes requesting a cloud client manager that is configured to communicate an authorized push notification request that includes token information assigned by the third party provider and uniquely associated with the mobile device, to the push notification resource via a REST compliant application programming interface.

In accordance with information handling system embodiments of disclosed subject matter, an information handling system suitable for providing the MPS may include a processor and a memory or other form computer readable medium including processor executable instructions for causing the processor to perform particular mail polling operations including, as a non-limiting example, receiving a mail update request from a mail user agent of a mobile device, launching a polling thread for performing a long poll of an MDA on behalf of the mail user agent, and initiating a push notification request responsive to detecting a response to the polling thread from the MDA, wherein the push notification request may cause a cloud-based push notification resource of a third party provider to push a mail notification to the mobile device.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and unless indicated otherwise, all drawings are in accordance with the present invention wherein:

FIG. 1 illustrates a block diagram of a mobile device polling an MDA to receive new email stored in an EMS;

FIG. 2 illustrates a block diagram of one implementation of a mobile device receiving push notifications of new mail from a push notification resource;

FIG. 3 illustrates a block diagram of a platform for providing mobile devices with push notifications of new mails from a push notification resource;

FIG. 4 illustrates messages exchanged among elements of the FIG. 3 platform;

FIG. 5 illustrates a first information handling system; and

FIG. 6 illustrates a second information handling system.

### DETAILED DESCRIPTION

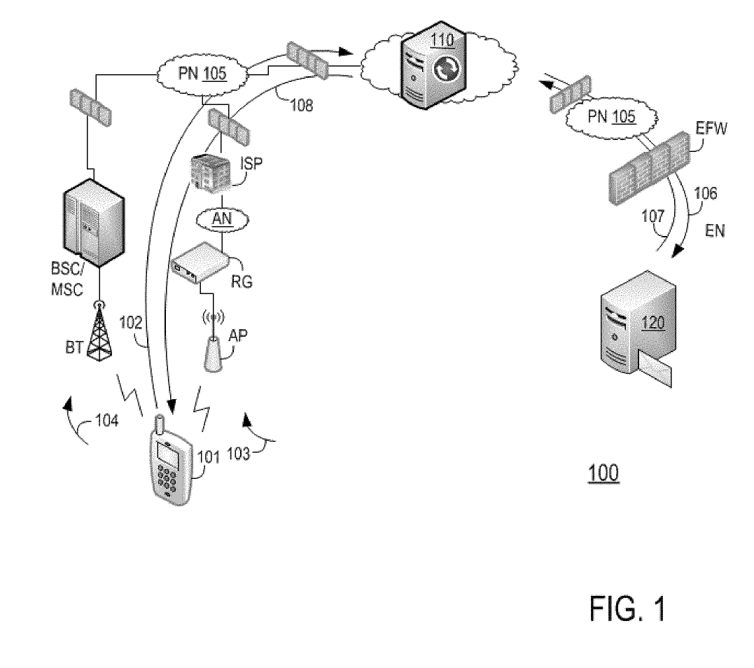

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, power supplies, air movers (e.g., fans and blowers) and/or any other components and/or elements of an information handling system.

FIG. 1 illustrates a mobile device 101 polling an MDA 110 to retrieve any new mail messages in EMS 120 for an EMS mail account associated with mobile device 101. Mobile device 101 encompasses a number of different devices and device types including, as non-limiting examples, mobile phones, smartphones, tablet computers, ruggedized mobile computers, mobile printers, mobile point-of-sale devices, and other suitable mobile devices.

As depicted in FIG. 1, mobile device 101 sends MDA 110 a polling request 102 that includes credentials for a particular mail account on EMS 120. The particular mail account is generally, if not always, a mail account of a primary user of mobile device 101. The mail account credentials include, as non-limiting examples, the applicable email address and email account password. The credentials may also include, in at least some embodiments, a unique identifier of the mobile device 101 and/or a unique identifier of a mail user agent (not explicitly depicted in FIG. 1) of mobile device 101. In some embodiments, mail account credentials may also include identifiers of the incoming and outgoing mail servers including within EMS 120 (but not depicted individually in FIG. 1), identifiers of an incoming and outgoing mail protocols and TCP ports, and so forth.

FIG. 1 suggests that mail update request 102 may traverse any of at least two paths between mobile device 101 and MDA 110, a WiFi path 103, which proceeds through an access point AP, a residential gateway RG, an access network AN, an Internet service provider ISP, and a public network PN 105 that represents the Iternet. Alternatively, the update request may travel a wireless wide area network (WWAN) path 104, which proceeds through a cellular base station BT, an integrated base station controller/mobile switching center (BSC/MSC), and PN 105.

The MDA 110 of FIG. 1, which is illustrated as a cloud-based resource, responds to polling request 102 by sending a mail access request 106 to EMS 120, which is illustrated in FIG. 1 as an on-premises or installed server deployment located behind an enterprise firewall EFW that isolates an enterprise network EN and its resources from the adjacent public network PN 105. Because the mail access request 106 must traverse enterprise firewall EFW, mail access requests must include or otherwise present credentials sufficient to access the applicable mail account of EMS 120.

The EMS 120 of FIG. 1 responds to mail access request 106 by sending mail access response 107 back to MDA 110. If new mail was present, mail access response 108 may include the one or more individual mail messages or metadata for the individual mail messages. If no new email was present mail access response 107 will so indicate. Upon receipt of mail access response 107, the MDA 110 of FIG. 1 responds to polling request 102 with a polling response 108 that may include new email messages, if any, metadata for any new mail messages, or an indication of no new email.

Typically, the polling request that initiates the delivery of new email to a mobile device is issued by an mail user agent (sometimes informally referred to as a mail client or mail client application) of mobile device 101. End user demands may favor or necessitate comparatively frequent, e.g., 2 to 12 updates per hour. The mail user agent, however, like all applications executing on mobile device 101, operates subject to the control of the mobile device operating system, which may and generally does control and limit the extent to which any particular application program, including any mail user agent, can keep an active background process executing. In the case of the mail user agent, as an example, a background process is required to maintain a network connection with MDA 110 resource and to poll MDA 110 from time to time. As suggested, however, the mobile device operating system may terminate any or all processes running, including processes executing in the background, to conserve power or to enforce, support, or facilitate any other operating system policy.

In addition, even if the mobile device operating system permits or supports a persistent background process for mobile device synchronization, the background process would undesirably consume power, requiring more frequent charging of the mobile device's battery. Thus, the direct polling of MDA 110 by mobile device 101 illustrated in FIG. 1 is not highly suitable as a technique for ensuring close-in-time notification and/or delivery of new mail message to a mobile device 101.

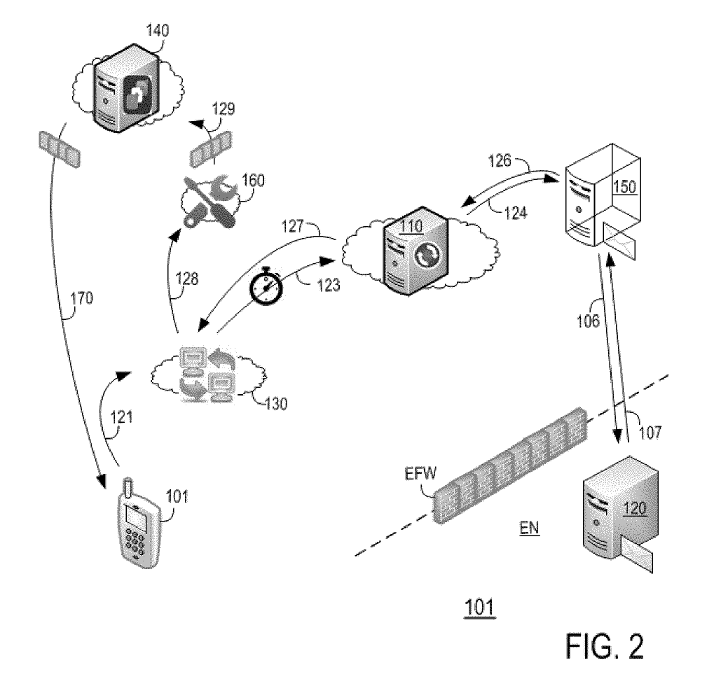

FIG. 2 illustrates a mobile device update platform that addresses at least some of the issues inherent in the direct polling illustrated in FIG. 1. FIG. 2 illustrates a polling resource 130 employed in conjunction with a push notification resource 140 and a virtual mail server 150 to provide mail updates to mobile device 101. An enterprise that wishes to push email notifications to entity-affiliated mobile devices, whether entity-owned or user-owned, may acquire or license access to polling resource 130 from a developer or service provider, who may be associated with the developer/provider of ems 120, the developer/provider of MDA 110, or both.

In FIG. 2, mobile device sends a mail notification message 121 to polling resource 130 to inform polling resource 130 that mobile device 101 wishes to receive push notifications of new mail. Mail notification message 121 may include mail credentials the same as or similar to the credential described with respect to mail notification request 102 in FIG. 1. In addition, the mail notification message 121 may include an identifier for MDA 110 and an identifier for virtual mail server 150, which represents a cloud-based duplicate of mail and other confidential information including, as examples, contacts, calendars, notes, and the like, stored in EMS 120. Specifics regarding the manner in which confidential data in EMS 120 is duplicated in VMS 150 is beyond the scope of the present disclosure.

The polling resource 130 illustrated in FIG. 2 responds to mail notification message 120 by launching a polling thread 123 to poll MDA 110 on behalf of mobile device 101. Unlike the polling request 102 of FIG. 1, however, polling thread 123 represent a long poll process in which the polling resource 130 maintains the network connection with the polled resource, MDA 110 in this case, until a response from the polled resource is received or until the connection is explicitly terminated in accordance with a termination policy intended to address orphaned or abandoned threads. Depending upon the applicable termination policy, the polling thread 123 may persist for hours, days, or longer.

The long poll of MDA 110 associated with polling thread 123 illustrated in FIG. 2 causes MDA 110 to send an email access request 124 to VMS 150, which returns an email access response 126 to MDA 110. As in the case of the response 107 from EMS 120 to MDA 110 of FIG. 1, the response 126 from VMS 150 to MDA 110 may include individual messages, metadata for new email messages, some combination of the two, simply a binary indication of the presence or absence of new mail. Accordingly, response 126 may simply indicate that no new mail is present. However, whereas the response 107 from EMS 120 to MDA 110 indicating no new data in FIG. 1 produced a corresponding no-response from MDA 110 to mobile device 101, the long poll represented by polling thread 123, rather than forwarding a response indicating no new data, may simply “wait” by re-issuing mail access request 124 and evaluating mail access 126 on a repeated basis. Assuming that new mail eventually arrives at VMS 150 before a policy-based termination of the polling thread network connection, MDA 110 will send a long poll response 127 to the long poll associated with polling request 123 to inform polling resource 130 that there is new mail available.

The polling resource 130 illustrated in FIG. 2, upon receiving long poll response 127, initiates a push notification sequence that includes a push request message 128 from polling resource 130 to a cloud-based network utility 160, that provides, as at least one of its functions or services, a REST-compliant push notification interface enabling utility 160 to communicate with a push notification API (not depicted) exposed by push notification resource 140 and to send a push notification request 129. Push notification resource 140, typically provided by a provider of the mobile device operating system, upon receiving a properly authenticated push notification request 129 is illustrated pushing a notification 170 to mobile device 101.

While the configuration illustrated in FIG. 2 addresses problems associated with direct polling of MDA 110 by mobile device 101, FIG. 2 introduces at least two significant security and vulnerability concerns. First, the VMS 150 illustrated in FIG. 2 represents an in-the-cloud, i.e., beyond-the-firewall, duplication, generated under the control of a third party, of an enterprise's entire confidential email data store. In addition, delegating the push notification interaction with push notification resource 140 to a service provider requires the enterprise to credentials for each applicable mail account and tokens for each mobile device 101.

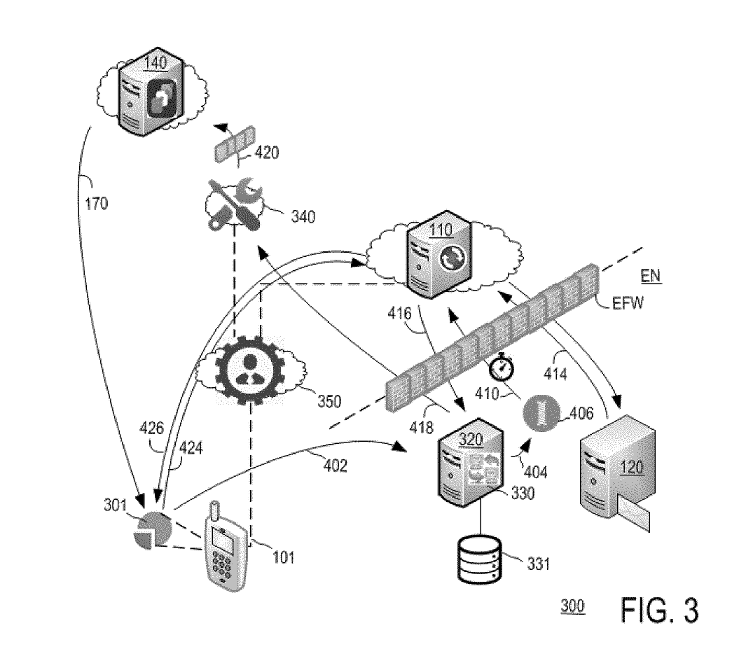

FIG. 3 illustrates a platform 300 that supports email notifications pushed to mobile devices while addressing at least some of the concerns raised by the notification platforms of FIG. 1 and FIG. 2. FIG. 3 also illustrates at least some system and device management resources and features that may be suitable for use in conjunction with enterprise-based email push notification services. In this respect, the illustrated mobility device 101 includes a mobile device workspace (MDW) 301 and the illustrated platform 300 includes an enterprise mobility management resource 350.

MDW 301 may be implemented as an application that supports a separate and secure workspace for business or professional use and enables the user to access enterprise data and applications securely, without exposing the enterprise's confidential information to a non-secure environment. MDW 301 addresses the pervasive use of mobile device 101 may for both business purposes and personal purposes and the increasing importance of functionality enabling an enterprise to enforce mobile device policies selectively and to control or erase mobile device applications and data selectively. Although FIG. 3 illustrates MDW 301 in conjunction with mobile device 101, platform 300 may be implemented with a mobile device 101 that may not include and may not support an architecturally protected partition for data, applications, and access.

The enterprise mobility management resource 350 includes one or more mobile configuration and management features. The enterprise mobility management resource 350 may support over-the-air distribution of applications, data, and configuration settings for both enterprise-owned and user-owned mobile devices 101.

The platform 300 illustrated in FIG. 3 includes MPS 330 tasked with maintaining a record of MDWs 301 that have requested mail notifications, pinging MDA 110 on behalf of the applicable MDWs 301, and initiating push notification requests when new email is present. Embodiments of MPS 330 may launch polling threads that send long poll requests to MDA 110 and, in these embodiments, MPS 330 may maintain a polling thread database 331 to monitor the age of and demand for each polling thread and to terminate polling threads that satisfy any of one or more age-based, demand-based, or other suitable criteria.

The MPS 330 illustrated in FIG. 3 is implemented as a feature or service of a premised-based resource referred to as the on-premises gateway (OPG). OPG 320 may include functions for extending cloud-based management console functionality to encompass features including as examples, single sign-on, exportation of asset inventories into a management application, and an active directory connector. Single sign-on enables management console administrators and mobile administrator users to use domain credentials instead of local management console credentials for certain functions. Active directory connector refers to management features that support bulk import and manual synchronization of Microsoft® Active Directory® groups and users.

Although the MPS 330 of FIG. 3 resides in OPG 320, MPS 330 may reside in a stand-alone on-premises resource or a different on-premises resource. In on-premises deployments of MPS 330, the polling thread database 331 may be implemented as an on-premises database that is locally accessible to MPS 330. On-premise deployments of MPS 320 may have a security benefit by keeping mail account credentials within the enterprise firewall EFW when MPS 330 is invoked by a MDW 301. MPS 330 may, nevertheless, be deployed as a cloud based resource in other embodiments.

The platform 300 of FIG. 3 further includes a cloud-based utility resource 340. Utility resource 340 may include one or more interfaces for communicating with application program interfaces (APIs) exposed by various cloud based third party services including push notification resource 140. The utility resource 340 may be configured to submit an authorized request to push a notification to a particular MDW 301 that is uniquely and securely identified within or in conjunction with the request.

Upon receiving an email notification 170 pushed from push notification resource 140, MDW 301 may then “ping” MDA 110 directly, in a manner analogous to the direct polling of MDA 110 by mobile device 101 illustrated in and described with respect to FIG. 1, to retrieve the new mail. MDW 301 may support one or more low power operational states to conserve power consumption during intervals of no or low activity. In these embodiments, MDW 301 may be configured to wake-when-pushed, i.e., to detect and respond to push notifications, including mail notification 170, even when otherwise “sleeping,” thereby enabling MDW 301 to transition to low power mode operation aggressively without sacrificing data currency.

In this manner, the platform 300 of FIG. 3 supports mobile device mail notifications by implementing an “off-device” MPS, i.e., a polling service not executing on the mobile device itself and, therefore, not subject to control by the mobile device operating system. The MPS may launch polling threads for one or more mobile devices that indicate a preference for mail notifications or otherwise register with the MPS.

The polling threads launched by MPS 330 include long poll requests to MDA 110 that convey credentials for the applicable mail account. A polling thread may persist until either new mail arrives or the thread is terminated in accordance with a policy criterion, e.g., a polling thread age criterion to detect and terminate orphaned polling threads.

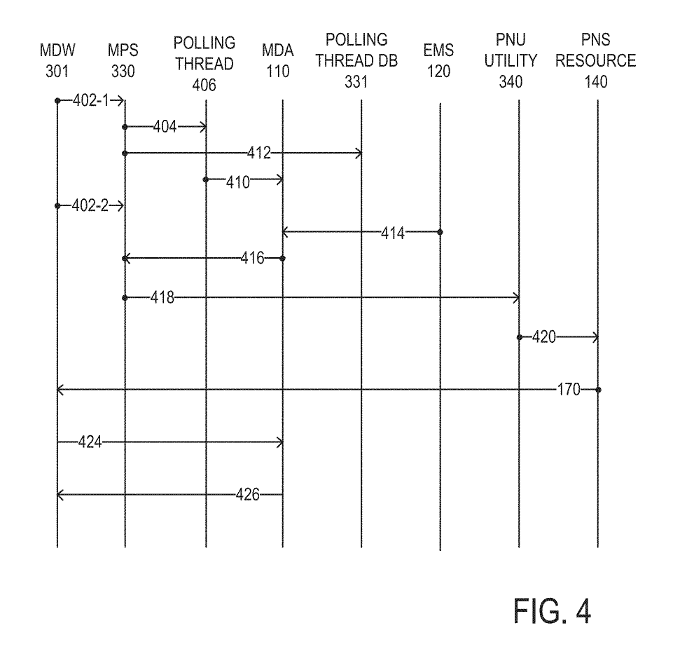

FIG. 4 illustrates a sequence of messages, requests, or other communications of information pertaining to email notifications exchanged among the various elements of the platform 300 illustrated in FIG. 3, although the specific sequences of communications communicated among the elements of platform 300 may vary.

As depicted in FIG. 4, MDW 301 may initiate a mail notification process 400 to enable push notifications when new mail arrives at a remotely located enterprise mail server by sending an email notification request 402 to MPS 330. MDW 301 may include, within the email notification request 402, credentials for the applicable email account on EMS 120. The email notification request 402 may be sent to OPG 320 or elsewhere depending upon where MPS 330 is installed. As previously suggested, implementing MPS 330 within OPG 320 or within another resource located behind enterprise firewall EFW beneficially maintains mail account credentials submitted with the request 402 within the enterprise's domain of control. If a particular enterprise operates two or more OPGs 320, the email notification request 402 may be delivered to prevent multiple active notification requests for a single MDW 301.

The email notification request 402 illustrated in FIG. 4 causes MPS 330 to launch (404) an instance of a polling thread 406 specific to MDW 301 that pings MDA 110 on behalf of the applicable MDW 301. In the embodiment depicted in FIG. 4, polling thread 406 pings MDA 110 by sending a long-poll request 410 to MDA 110.

MPS 330 may create (operation 412) an entry in a polling thread database 331 when polling thread 406 is launched to record data from which MPS 330 can determine one or more parameters pertaining to the length of time polling thread 406 has been executing relative to one or more events. In at least one embodiment, MPS 330 monitors at least two parameters, either of which may necessitate or trigger termination of the applicable polling thread 406. The two polling thread parameters monitored by the MPS 330 of FIG. 3 and FIG. 4 are referred to herein as an expiration parameter and a timeout parameter.

The expiration parameter indicates the age of a polling thread 406, i.e., the difference between the current time/date and the time/date when the polling thread was launched. The expiration parameter may be effective for terminating polling thread 406 where the MDW 301 is receiving extremely little email traffic or where MDA 110 is non-responsive. If the expiration parameter achieves a threshold value, MPS 330 may terminate the polling thread 406. Although the threshold value is an implementation detail, a default value of the expiration threshold may be somewhere in the range of approximately 16 to approximately 30 hours, with 24 hours as a representative default.

The timeout parameter indicates the length of time since the MDW 301 last sent a mail notification request 402. The timeout parameter may be effective in terminating polling threads when the applicable MDW 301 has been inactive for an extended interval. If the timeout parameter achieves its threshold value, MPS 330 may terminate the polling thread 406. Again, while the threshold value is an implementation detail, a default value for the timeout threshold may be in the range of approximately 4 to 8 hours, with 6 hours as a representative default, loosely coinciding, in some embodiments, with the amount of sleep the applicable mobile device might expect on average. In some embodiments, at least one the two parameter may be specified relative to the other of the two parameters. For example, a timeout parameter may be indicated explicitly and the expiration parameter may be specified by indicating an expiration/timeout ratio. In these embodiments, a default value of the ratio may be anywhere in the range of 2 to 6 with 4 serving as a possible default ratio.

MPS 330 may record timestamps or other information indicative of the applicable parameters. Referring to FIG. 4, for example, MPS 330 may record a timestamp when MPS 330 launches polling thread 406 via operation 404 and similarly, MPS 330 may record a timestamp associated with each mail notification request 182. MPS 330 may access the applicable termination thresholds and determine a time/date at which the polling thread 406 will be terminated, subject to any event criteria. The timeout parameter, for example, may be reset each time MDW 301 issues a notification request 402. Other termination parameters, including the expiration parameter, may be unconditionally enforced such that, as an example, no polling thread 406 can remain active for longer than the expiration threshold.

In the sequence 400 illustrated in FIG. 4, MDW 301 resends a second email notification request 402-2 to MPS 330 some amount of time after mail notification request 402-1 was sent. If the timeout threshold is less than the expiration threshold and the amount of time that transpired between mail notification requests 402-1 and mail notification request 402-2 is less than the timeout threshold, polling thread 406 will still be active when mail notification request 402-2 is received. When MPS 330 receives a mail notification request 402 for an MDW 301 and determines that a previously launched polling thread 406 for the MDW 301 has not been terminated, MPS 330 may simply reset the timeout parameter, enabling the polling thread 406 to continue its polling through the end of the expiration interval or the end of the current timeout window, whichever occurs first.

If the network connection associated with a polling thread 406 is disrupted during an active interval, MPS 330 may re-establish the polling thread 406. In this manner, a MDW 301 can achieve substantially uninterrupted data currency with a small commitment of processing resources. In the example embodiments referred to above, substantially uninterrupted mail notification currency can be achieved by sending as few as 4 mail notification requests a day.

MDW 301 may also be able to cancel an active polling thread 406 by sending a “cancel poll” request (not depicted in FIG. 4) to MPS 330.

If a new email for the applicable email address/account associated with MDW 301 is received by EMS 120 during the pendency of a long pole request 410, EMS 120 notifies (operation 414) MDA 110 and MDA returns a response 416 to MPS 330. Upon receiving response 416 to the long poll request 410, MPS 330 may initiate an authorized push notification request to push notification resource 140 on behalf of MDW 301.

FIG. 4 illustrates MPS 330 issuing an authenticated request 418 to a cloud-based utility resource 340 that includes or supports an interface configured to communicate with an API exposed by the push notification resource 140. If the request 418 does not include push notification credentials required by the API, the utility resource 340 may obtain the required credentials from enterprise mobility management resource 350, beneficially making it unnecessary to for the MPS 330 to maintain or have access to the push notification credentials.

Upon receiving and verifying authenticated message 418, utility resource 340 provides an API-compliant push notification request 420, including any required push notification credentials, to push notification resource 140, which, upon verifying the credentials provided with the request 420, pushes mail notification 170 to the MDW 301.

If MDW 301 is asleep or otherwise operating in a reduced power consumption state, the push notification 170 may cause MDW 301 to transition to an operational state sufficient to announce or otherwise inform the user of MDW 301 that EMS 120 has received new mail. MDW 301 may then initiate a direct poll 424 of MDA 110 in a manner analogous to the direct polling described with respect to FIG. 1 above. FIG. 4 illustrates MDA 110 responding to the direct poll 424 by delivering the new mail message(s) 426 or metadata indicative of the new mail message(s).

By providing an enterprise-controlled resource specifically tasked with polling MDA 110 on behalf of a population of mobile devices and enabling mobile devices to delegate the MDA polling to the polling resource, the illustrated platform enables the enterprise to realize nearly immediate and nearly continuous notification of new mail for its mobile device users without significantly impacting mobile device functionality or battery life.

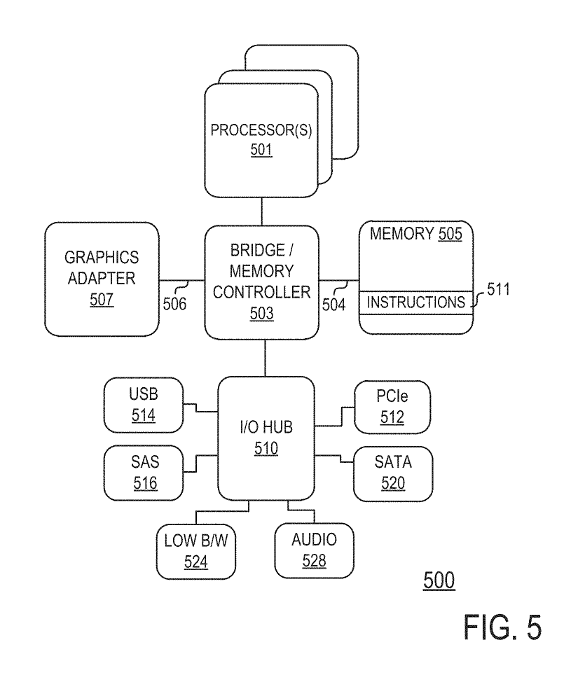

FIG. 5 illustrates elements of an information handling system 500 as a server that implements any one or more servers, systems, and resources described herein including, as non-limiting examples, MDA 110, EMS 120, OPG 320, and mobility management resource 350. The information handling system 500 illustrated in FIG. 5 includes one or more general-purpose processors 501 coupled to a bridge/memory controller 503, sometimes referred to as a north bridge, that controls a memory 505 via a memory bus 504 and a graphics adapter 507 via a graphics bus 506. In at least one embodiment, memory bus 504 is a double data rate (DDR) memory bus and memory 505 is implemented with synchronous DRAM (SDRAM) and graphics bus 506 is an extended Peripheral Components Interconnect (PCIe) bus. Other embodiments may employ different technologies and protocols.

The information handling system 500 of FIG. 5 further includes an I/O hub 510, sometimes referred to as a south bridge, that provides or supports various I/O interfaces, controllers, and adapters. The depicted I/O hub 510 includes a peripheral component interface express (PCIe) controller 512 supporting one or more PCIe expansion busses, a universal serial bus (USB) controller 514 supporting a plurality of USB-compliant high speed serial busses, and controllers for various mass storage protocols including a Serial Attached SCSI (SAS) controller 516 and a Serial ATA (SATA) controller 520. A low bandwidth controller 524 represents any of various busses including, as examples, Low Pin Count (LPC), serial peripheral interface (SPI), and Inter-Integrated Circuit (I2C), suitable for low data rate and legacy devices (not depicted) including, as non-limiting examples, a BIOS flash storage device and a Super I/O device or any one or more Super I/O peripherals. An audio adapter 528 may include an audio coder/decoder (codec) for receiving audio via a microphone (not depicted) and generating audio output for a speaker (not depicted). Any of the elements shown in FIG. 5 may encompass two or more distinct controllers or adapters. Conversely, any group of two or more elements shown separately in FIG. 5 may be integrated within a single semiconductor device, chip set, or printed circuit board. Although FIG. 5 identifies particular standards, protocols, or interfaces, other embodiments may achieve analogous functions employing one or more different standards, protocols, or interfaces.

FIG. 5 also illustrates processor executable instructions 511 stored in memory 505. Instructions 511 may include operating system instructions as well as instructions supporting one or more application programs. Processor executable instructions 511, when executed by processor(s) 501 may cause processor(s) 501, to perform various operations. As an example, instructions 511 may include mail polling service instructions enabling information handling system 500 to implement the MPS 330 illustrated in FIG. 3 and described in the corresponding description.

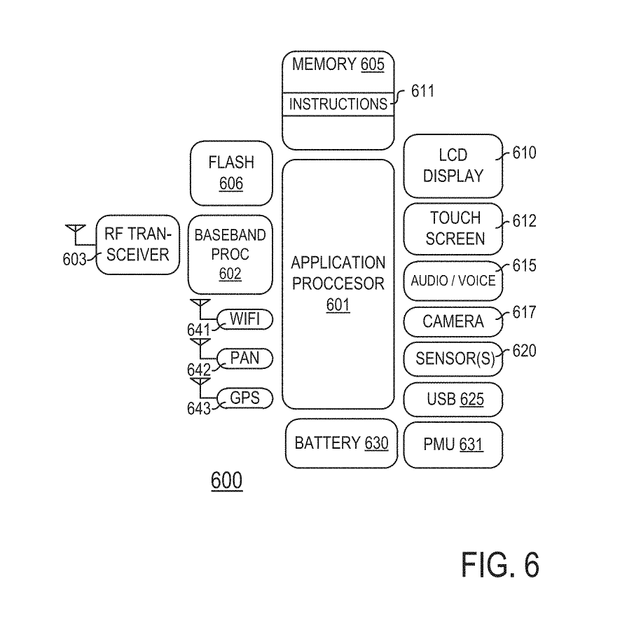

FIG. 6 illustrates elements of an information handling system 600, which may be suitable for use as mobile device 101, including an application processor 601 and a baseband processor 602. The depicted application processor 601 includes interfaces to a memory 605, flash storage 606, LCD display 610, touchscreen controller 612, audio/voice module 615, digital camera 617, one or more sensors 620, and a USB controller 625.

Memory 605 may be a implemented with SDRAM or another type of volatile storage. Flash storage 606 may include NOR flash, NAND flash, or both. Audio/voice module 615 includes an audio coder/decoder (CODEC), digital-to-analog and analog-to-digital converters, one or more amplifiers, a microphone interface for coupling to a microphone (not depicted), and a speaker interface for coupling to one or more speakers (not depicted). Digital camera 617 may include a CCD or CMOS image capture array. Sensor(s) 620 may include accelerometers or gyroscopes, force sensors, environmental sensors including temperature and humidity sensors, light/optical sensors, and so forth. The USB controller 625 may be a USB on-the-go (OTG) controller that enables information handling system 600 to act as either a USB host or client depending upon the context.

Informational handling system 600 is powered by a lithium ion or other type of rechargeable battery 630 in combination with a power management unit 631 that includes a battery charger, various DC-to-DC converters, and power management logic/firmware supporting one or more reduced power states.

The application processor 601 illustrated in FIG. 6 interfaces with a Global Position System (GPS) receiver 643 and with one or more “local wireless” transceivers including a WiFi transceiver 641 and a personal area network (PAN) transceiver 642 that may represent a Bluetooth transceiver, a Zigbee transceiver, a transceiver for another suitable PAN, or any combination thereof. Baseband processor 602 and RF transceiver 603 are responsible for cellular communication signaling. RF transceiver 603 may include transceivers and power amplifiers supporting any suitable modulator/demodulator and frequency band(s), whether 2G, 3G, 4G or beyond.

FIG. 6 illustrates processor executable instructions 611 stored in memory 605. Instructions 611 may include mobile device operating system instructions as well as instructions for one or more application programs.

Processor executable instructions 611, when executed by processor(s) 601 may cause processor(s) 601, to perform various operations. As an example, instructions 611 may include mobile device workspace instructions enabling information handling system 600 to implement the MDW 301 of the mobile device 101 illustrated in FIG. 3 and described in the corresponding description.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method of notifying a mobile device of mail updates, the method comprising:
detecting, by an off-device polling resource, a mail notification request associated with the mobile device;
launching a polling thread to perform polling thread operations including:
establishing a network connection with a mail delivery agent in communication with an enterprise mail server; and
executing a long-poll of the mail delivery agent on behalf of the mobile device to determine if the enterprise mail server has new mail for an mail account associated with the mobile device;
responsive to receiving a response from the polling thread, invoking a utility resource to request a push notification resource to push a mail notification to the mobile device.

2. The method of claim 1, terminating the polling thread in accordance with particular criteria when no response to the polling thread is received.

3. The method of claim 2, wherein the particular criteria include an expiration criterion comprising a duration of the long-poll exceeding an expiration interval.

4. The method of claim 3, wherein the particular criteria include a timeout criterion comprising an interval between the mail notification request and a subsequent mail notification request exceeding a timeout interval.

5. The method of claim 4, wherein a default value of the expiration interval is approximately 24 hours and wherein a default value of the timeout interval is approximately 6 hours.

6. The method of claim 1, wherein the off-device polling resource comprises an on-premises gateway of an enterprise network, isolated from public networks by an enterprise firewall, and programmed with mail polling instructions for launching the polling thread in response to the mail notification request.

7. The method of claim 6, wherein the mail polling instructions include instructions for: launching the polling thread in response to the mail notification request subject to determining that no polling thread associated with the mobile device is currently active.

8. A non-transitory computer readable medium including processor executable instructions for causing a processor of a mail polling resource to perform mail polling operations comprising:
detecting a mail update request from a mobile device;
responsive to determining that no polling thread co/responding to the mobile device exists, launching a polling thread corresponding to the mobile device to poll a mail delivery agent for an indication of new mail for a mail account associated with the mobile device; and
responsive to detecting a response from the polling thread, initiating a push notification request to cause a push notification resource of a third party provider to push an indication of new mail to the mobile device;
wherein the polling thread is configured to perform polling operations comprising:
establishing a network connection with a mail delivery agent coupled to the EMS;
providing the mail delivery agent with mail credentials corresponding to the mobile account; and
performing a long-poll of the mail delivery agent for the indication of new email.

9. The computer readable medium of claim 8, wherein the long-poll persists until either:
returning a long poll response to the mail polling service; or
terminating in accordance with particular criteria before the polling thread returns a response.

10. The computer readable medium of claim 10, wherein the particular criteria include a duration between successive mail notification requests exceeding a timeout interval.

11. The computer readable medium of claim 11, wherein the particular criteria include a duration of the polling thread exceeding an expiration interval.

12. The computer readable medium of claim 10, wherein the polling operations include: creating a record corresponding to the polling thread in a database;
storing values indicative of the timeout interval and the expiration interval in the database record corresponding to the mobile device; and
monitoring a duration of the long poll and a duration of an interval since the mail notification request was sent.

13. The computer readable medium of claim 11, wherein a default value of the expiration interval is approximately 4× a default value of the timeout interval.

14. The computer readable medium of claim 14, wherein the default value of the expiration interval is in the range of approximately 18 to approximately 30 hours.

15. The computer readable medium of claim 8, wherein the mail polling resource comprises an on-premises gateway server on an enterprise network demarcated by an enterprise firewall.

16. The computer readable medium of claim 8, wherein establishing the network connection with the mail delivery agent includes:
obtaining mail account credentials for the mail account; and
providing the mail account credentials to the mail delivery agent in conjunction with the polling thread.

17. The computer readable medium of claim 8, wherein initiating the push notification request includes:
requesting a cloud client manager configured to communicate an authorized push notification request, including token information assigned by the third party provider and uniquely associated with the mobile device, to the push notification resource via a REST compliant application programming interface.

18. An information handling system, comprising:
a processor; and
a computer readable medium including processor executable instructions for causing the processor to perform operations comprising:
receiving a mail update request from a mail user agent of a mobile device;
launching a polling thread for performing a long poll of a mail delivery agent on behalf of the mail user agent;
responsive to detecting a response to the polling thread from the mail delivery agent, initiating a push notification request to cause a push notification resource of a third party provider to push a mail notification to the mobile device.

19. The information handling system of claim 19, wherein the mail delivery agent comprises a cloud-based enterprise active sync resource.
